(19) United States
(12) Patent Application Publication
(10) Pub. No.: US 2016/0316220 A1
(43) Pub. Date: Oct. 27, 2016

(54) VIDEO ENCODER MANAGEMENT STRATEGIES

(71) Applicant: Microsoft Technology Licensing, LLC, Redmond, WA (US)

(72) Inventors: Weidong Zhao, Bellevue, WA (US); Yongjun Wu, Bellevue, WA (US); Shyam Sadhwani, Bellevue, WA (US)

(73) Assignee: Microsoft Technology Licensing, LLC, Redmond, WA (US)

(21) Appl. No.: 14/692,672

(22) Filed: Apr. 21, 2015

(51) Int. Cl. H04N 19/51; G06K 9/46; H04N 7/15; H04N 19/124

(52) U.S. Cl. CPC H04N 19/51; H04N 19/124; G06K 9/46; H04N 7/155; G06K 2009/4666

(57) ABSTRACT

Innovations in how a host application and video encoder share information and use shared information during video encoding are described. The innovations can help the video encoder perform certain encoding operations and/or help the host application control overall encoding quality and performance. For example, the host application provides regional motion information to the video encoder, which the video encoder can use to speed up motion estimation operations for units of a current picture and more generally improve the accuracy and quality of motion estimation. Or, as another example, the video encoder provides information about the results of encoding the current picture to the host application, which the host application can use to determine when to start a new group of pictures at a scene change boundary. By sharing information in this way, the host application and the video encoder can improve encoding performance, especially for real-time communication scenarios.

### BACKGROUND

When video is streamed over the Internet and played back through a Web browser or media player, the video is delivered in digital form. Digital video is also used when video is delivered through many broadcast services, satellite services and cable television services. Real-time videoconferencing often uses digital video, and digital video is used during video capture with most smartphones, Web cameras and other video capture devices.

Digital video can consume an extremely high amount of bits. Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last two decades, various video codec standards have been adopted, including the ITU-T H.261, H.262 (MPEG-2 or ISO/IEC 13818-2), H.263, H.264 (MPEG-4 AVC or ISO/IEC 14496-10), and H.265 (HEVC or ISO/IEC 23008-2) standards, the MPEG-1 (ISO/IEC 11172-2) and MPEG-4 Visual (ISO/IEC 14496-2) standards, and the SMPTE 421M standard. A video codec standard typically defines options for the syntax of an encoded video bitstream, detailing parameters in the bitstream when particular features are used in encoding and decoding. In many cases, a video codec standard also provides details about decoding operations a decoder should perform to achieve conformant results in decoding. Aside from codec standards, various proprietary codec formats (such as VP8, VP9 and other VPx formats) define other options for the syntax of an encoded video bitstream and corresponding decoding operations.

In some cases, a video encoder is managed by a higher-level application for a real-time conferencing service, broadcasting service, media streaming service, media file management tool, remote screen/desktop access service, or other service or tool. As used herein, the term “host application” generally indicates any software, hardware, or other logic for a service or tool, which manages, controls, or otherwise uses a video encoder. The host application and video encoder can interoperate by exchanging information across one or more interfaces exposed by the video encoder and/or one or more interfaces exposed by the host application. Typically, an interface defines one or more methods as well as one or more attributes or properties (generally, “properties”). The value of a property can be set to control some behavior or functionality of the video encoder (or host application) exposing the interface. A method of an interface can be called to cause the video encoder (or host application) that exposes the interface to carry out some operation. Previous approaches are limited in terms of the type of information shared by a host application to help a video encoder perform certain types of encoding operations, and they are limited in terms of the type of information shared by a video encoder to help a host application control overall encoding.

### SUMMARY

In summary, the detailed description presents ways for a host application to share information with a video encoder to help the video encoder perform certain encoding operations, and it further presents ways for a video encoder to share information with a host application to help the host application control overall encoding. For example, the host application provides regional motion information to a video encoder, which the video encoder uses to guide motion estimation operations for units of a current picture. Using regional motion information can speed up motion estimation by allowing the video encoder to identify suitable motion vectors for units of the current picture more quickly, and more generally can improve the accuracy and quality of motion estimation. Or, as another example, the video encoder provides information about the results of encoding the current picture to the host application, where the results information includes a quantization value and a measure of intra unit usage for the current picture. The host application can use the results information to control encoding for one or more subsequent pictures, e.g., determining when to start a new group of pictures at a scene change boundary. By sharing information and using shared information in this way, the host application and the video encoder can improve performance in terms of encoding quality and encoder speed (and hence user experience), especially for real-time communication scenarios.

According to one aspect of the innovations described herein, a host application selectively enables the use of regional motion information by a video encoder. For example, the host application queries an external component regarding the availability of regional motion information and, if regional motion information is available, enables the use of regional motion information by the video encoder. The host application then receives regional motion information for a current picture of a video sequence, and provides the regional motion information for the current picture to the video encoder. The video encoder receives the regional motion information for the current picture. Then, the video encoder uses the regional motion information during motion estimation for units of the current picture.

According to another aspect of the innovations described herein, a video encoder determines information that indicates the results of encoding of a current picture by the video encoder. The results information includes a quantization value (generally indicating a tradeoff between distortion and bitrate for the current picture) and a measure of intra unit usage (generally indicating how many blocks of the current picture were encoded using intra-picture compression, as opposed to inter-picture compression). The measure of intra unit usage can be a percentage of intra units in the current picture, a ratio of intra units to inter units in the current picture, or another type of measure. The video encoder provides the results information for the current picture to a host application. The host application receives the results information and, based at least in part on the results information, controls encoding for subsequent picture(s) of the video sequence (e.g., controlling properties of the encoder, input samples, or encoding operations).

The innovations can be implemented as part of a method, as part of a computer system configured to perform the method or as part of a tangible computer-readable media storing computer-executable instructions for causing a computer system, when programmed thereby, to perform the method. The various innovations can be used in combination or separately. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an example computer system in which some described embodiments can be implemented.

FIGS. 2a and 2b are diagrams of example network environments in which some described embodiments can be implemented.

FIG. 3 is a diagram of an example architecture for managing a video encoder according to some described embodiments.

FIG. 4 is a diagram of an example encoder system in conjunction with which some described embodiments can be implemented.

FIGS. 5 and 6 are flowcharts of generalized techniques for using regional motion information to assist video encoding, from the perspective of a host application and video encoder, respectively.

FIGS. 7 and 8 are flowcharts of generalized techniques for using results information to control video encoding, from the perspective of a host application and video encoder, respectively.

### DETAILED DESCRIPTION

The detailed description presents innovations in how a host application and video encoder share information and use shared information during video encoding, which can help the video encoder perform certain encoding operations and/or help the host application control overall encoding. For example, the host application provides regional motion information to the video encoder, which the video encoder can use to speed up motion estimation operations for units of a current picture, and more generally improve the accuracy and quality of motion estimation. Or, as another example, the video encoder provides information about the results of encoding the current picture to the host application, which the host application can use to determine when to start a new group of pictures at a scene change boundary. By sharing information in this way, the host application and the video encoder can improve encoding performance (and hence user experience), especially for real-time communication scenarios.

Some of the innovations presented herein are illustrated with reference to syntax elements and operations specific to the H.264 standard. The innovations presented herein can also be implemented for other standards or formats, e.g., the H.265/HEVC standard.

More generally, various alternatives to the examples presented herein are possible. For example, some of the methods presented herein can be altered by changing the ordering of the method acts described, by splitting, repeating, or omitting certain method acts, etc. The various aspects of the disclosed technology can be used in combination or separately. For example, a host application can share regional motion information with a video encoder without receiving and using results information from the video encoder. Or, the host application can receive and use results information from the video encoder without sharing regional motion information with the video encoder. Or, the host application and video encoder can share both regional motion information and results information. Different embodiments use one or more of the described innovations. Some of the innovations presented herein address one or more of the problems noted in the background. Typically, a given technique/tool does not solve all such problems.

### I. Example Computer Systems.

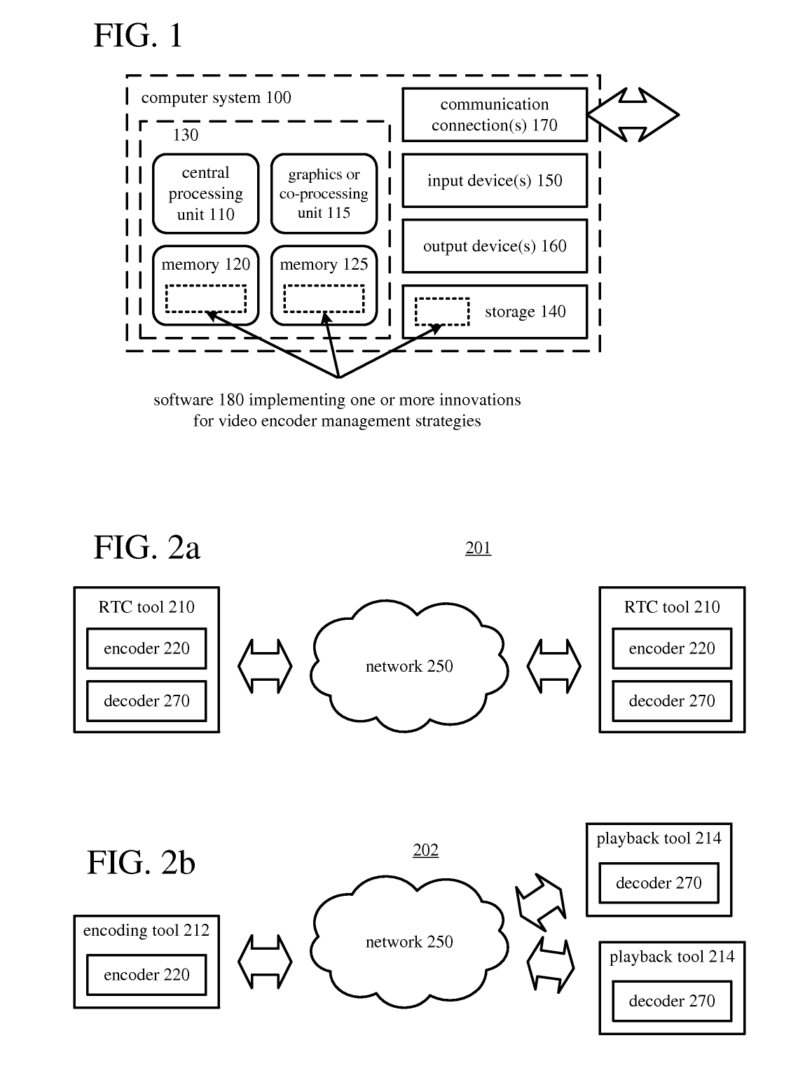

FIG. 1 illustrates a generalized example of a suitable computer system (100) in which several of the described innovations may be implemented. The computer system (100) is not intended to suggest any limitation as to scope of use or functionality, as the innovations may be implemented in diverse general-purpose or special-purpose computer systems.

With reference to FIG. 1, the computer system (100) includes one or more processing units (110, 115) and memory (120, 125). The processing units (110, 115) execute computer-executable instructions. A processing unit can be a general-purpose CPU, processor in an ASIC or any other type of processor. In a multi-processing system, multiple processing units execute computer-executable instructions to increase processing power. For example, FIG. 1 shows a CPU (110) as well as a GPU or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for video encoder management strategies, in the form of computer-executable instructions suitable for execution by the processing unit(s).

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, operating system software (not shown) provides an operating environment for other software executing in the computer system (100), and coordinates activities of the components of the computer system (100).

The tangible storage (140) may be removable or non-removable, and includes magnetic disks, magnetic tapes or cassettes, optical storage media such as CD-ROMs or DVDs, or any other medium which can be used to store information and which can be accessed within the computer system (100). The storage (140) stores instructions for the software (180) implementing one or more innovations for video encoder management strategies.

The input device(s) (150) may be a touch input device such as a keyboard, mouse, pen, or trackball, a voice input device, a scanning device, or another device that provides input to the computer system (100). For video, the input device(s) (150) may be a camera, video card, TV tuner card, screen capture module, or similar device that accepts video input in analog or digital form, or a CD-ROM or CD-RW that reads video input into the computer system (100). The output device(s) (160) may be a display, printer, speaker, CD-writer, or another device that provides output from the computer system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations presented herein can be described in the general context of computer-readable media. Computer-readable media are any available tangible media that can be accessed within a computing environment. By way of example, and not limitation, with the computer system (100), computer-readable media include memory (120, 125), storage (140), and combinations of any of the above. As used herein, the term “computer-readable media” does not encompass, cover, or otherwise include a carrier wave, propagating signal, or signal per se.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or computer device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a GPU, or a programmable logic device (“PLD”) such as a field programmable gate array (“FPGA”)) specially designed or configured to implement any of the disclosed methods.

For the sake of presentation, the detailed description uses terms like “determine,” “set,” and “use” to describe computer operations in a computer system. These terms are high-level abstractions for operations performed by a computer, and should not be confused with acts performed by a human being. The actual computer operations corresponding to these terms vary depending on implementation.

### II. Example Network Environments.

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (“RTC”) tool (210) includes both an encoder (220) and a decoder (270) for bidirectional communication. The RTC tool (210) is an example of host application, and it may interoperate with the encoder (220) across one or more interfaces as described in sections III, V, and VI. A given encoder (220) can produce output compliant with the H.265 standard, SMPTE 421M standard, H.264 standard, another standard, or a proprietary format, or a variation or extension thereof, with a corresponding decoder (270) accepting encoded data from the encoder (220). The bidirectional communication can be part of a videoconference, video telephone call, or other two-party or multi-party communication scenario. Although the network environment (201) in FIG. 2a includes two RTC tools (210), the network environment (201) can instead include three or more RTC tools (210) that participate in multi-party communication.

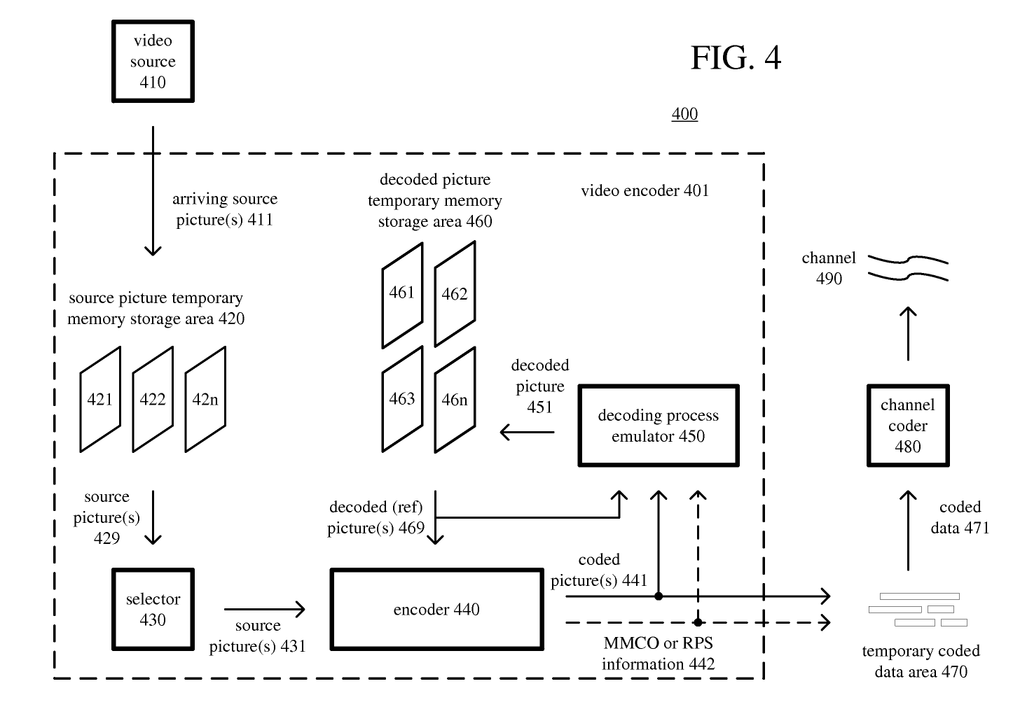

Overall, an RTC tool (210) manages encoding by an encoder (220). FIG. 4 shows an example encoder system (400) that can be included in the RTC tool (210). Alternatively, the RTC tool (210) uses another encoder system. An RTC tool (210) also manages decoding by a decoder (270).

In the network environment (202) shown in FIG. 2b, an encoding tool (212) includes an encoder (220) that encodes video for delivery to multiple playback tools (214), which include decoders (270). The unidirectional communication can be provided for a video surveillance system, web camera monitoring system, remote desktop conferencing presentation or other scenario in which video is encoded and sent from one location to one or more other locations. The encoding tool (212) is an example of host application, and it may interoperate with the encoder (220) across one or more interfaces as described in sections III, V, and VI. Although the network environment (202) in FIG. 2b includes two playback tools (214), the network environment (202) can include more or fewer playback tools (214). For example, one encoding tool (212) may deliver encoded data to three or more playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 4 shows an example encoder system (400) that can be included in the encoding tool (212). Alternatively, the encoding tool (212) uses another encoder system. The encoding tool (212) can also include server-side controller logic for managing connections with one or more playback tools (214). A playback tool (214) can include client-side controller logic for managing connections with the encoding tool (212).

### III. Example Architectures for Video Encoder Management.

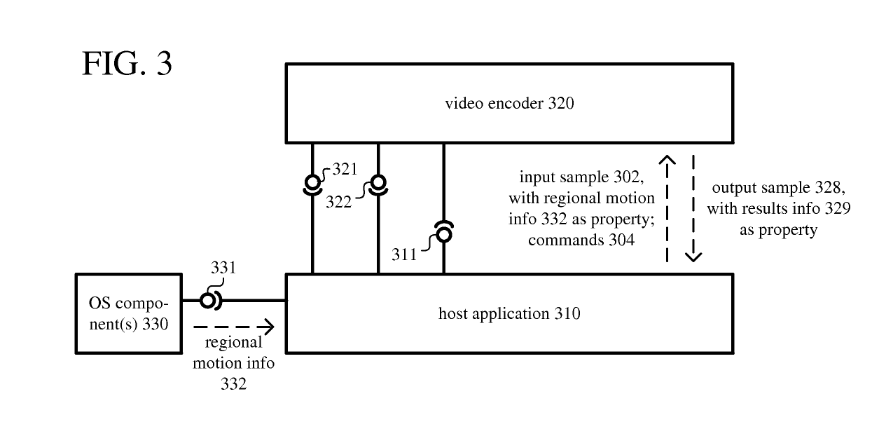

FIG. 3 shows an example architecture (300) for managing a video encoder according to some described embodiments. The example architecture (300) includes a host application (310), a video encoder (320), and an external component (330), which interoperate by exchanging information and commands across interfaces.

The external component (330) can be an operating system component (e.g., providing hints about movements of windows or other user interface elements, for screen content encoding), positioning component (e.g., for a global positioning system), accelerometer (e.g., from a wearable device or other portable device), image stabilization component, or other external component capable of providing regional motion information (332) for pictures. The external component (330) can be part of a wearable device (such as a smartwatch) or other portable computing device. The external component (330) exposes an interface (331), across which the external component (330) provides regional motion information (332) to the host application (310). For example, the regional motion information (332) is provided in response to a call to a method of the interface (331), as an event the host application (310) has registered to receive, or through another mechanism. Alternatively, the host application (310) can expose an interface across which the external component (330) provides the regional motion information (332). Example options for organization of the regional motion information (332) are described in section V.

The video encoder (320), which can be software, firmware, hardware, or some combination thereof. The video encoder (320) can encode video to produce a bitstream consistent with the H.264 standard, the H.265 standard, or another standard or format.

The video encoder (320) exposes an interface (321), which includes attributes and properties (generally, “properties”) specifying capabilities and settings for the video encoder (320), along with methods for getting the value of a property, setting the value of a property, querying whether a property is supported, querying whether a property is modifiable, and registering or unregistering for an event from the video encoder (320). For example, the interface (321) is a variation or extension of the ICodecAPI interface defined by Microsoft Corporation. Alternatively, the interface (321) is defined in some other way. As described in section V, the interface (321) can include a property that indicates whether the video encoder (320) accepts regional motion information (that is, the property indicates whether the use of regional motion information is enabled). As described in section VI, the interface (321) can also include a property that indicates whether the video encoder (320) is able to provide information about the results of encoding to the host application (310) (that is, the property indicates whether the export of results information is enabled).

The video encoder (320) also exposes an interface (322), which includes methods for adding or removing a stream for the video encoder (320), causing the video encoder (320) to process (encode) an input sample, causing the video encoder (320) to process (output) an output sample, or causing the video encoder (320) to perform some other action related to encoding or management of encoding. For example, the interface (322) is the IMFTransform interface defined by Microsoft Corporation. Alternatively, the interface (322) is defined in some other way. The video encoder (320) can expose one or more other interfaces and/or additional interfaces.

The host application (310) can be a real-time conferencing tool, broadcasting tool, media streaming tool, media file management tool, remote screen/desktop access service, or other service or tool. The host application (310), which can be software, firmware, hardware, or some combination thereof, manages, controls, or otherwise uses the video encoder (320). The host application (310) can evaluate capabilities and settings of the video encoder (320) by getting values of properties of the interface (321). The host application (310) can control capabilities and settings of the video encoder (320) by setting values of properties of the interface (321). To encode a picture, the host application (310) provides an input sample (302) to the video encoder (320), e.g., using a method of the interface (322) exposed by the video encoder (320). Regional motion information (332) can be passed to the video encoder (320) as a property of an input sample (302). The host application (310) provides other commands to the video encoder (320) across the interface (322). The host application (310) also gets an output sample (328) from the video encoder (320), e.g., using a method of the interface (322) exposed by the video encoder (320). Results information (329) can be passed from the video encoder (320) as a property of the output sample (328). The host application (310) can expose one or more interfaces (such as the interface (311) shown in FIG. 3) to the video encoder (320).

### IV. Example Encoder Systems.

FIG. 4 is a block diagram of an example encoder system (400). The encoder system (400) can be a general-purpose encoding tool capable of operating in any of multiple encoding modes such as a low-latency encoding mode for real-time communication or remote desktop conferencing, a transcoding mode, and a higher-latency encoding mode for producing media for playback from a file or stream, or it can be a special-purpose encoding tool adapted for one such encoding mode. The encoder system (400) can be adapted for encoding of a particular type of content. The encoder system (400) can be implemented as part of an operating system module, as part of an application library, as part of a standalone application, or using special-purpose hardware. The encoder system (400) can use one or more general-purpose processors (e.g., one or more CPUs) for some or all encoding operations, use graphics hardware (e.g., a GPU) for certain encoding operations, or use special-purpose hardware such as an ASIC for certain encoding operations. Overall, the encoder system (400) receives a sequence of source video pictures (411) and encodes the source pictures (411) to produce encoded data as output to a channel (490).

The video source (410) can be a camera, tuner card, storage media, screen capture module, or other digital video source. The video source (410) produces a sequence of video pictures at a frame rate of, for example, 30 frames per second. As used herein, the term “picture” generally refers to source, coded or reconstructed image data. For progressive-scan video, a picture is a progressive-scan video frame. For interlaced video, in example embodiments, an interlaced video frame might be de-interlaced prior to encoding. Alternatively, two complementary interlaced video fields are encoded together as a single video frame or encoded as two separately-encoded fields. Aside from indicating a progressive-scan video frame or interlaced-scan video frame, the term “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source picture (411) is stored in a source picture temporary memory storage area (420) that includes multiple picture buffer storage areas (421, 422, . . . , 42n). A picture buffer (421, 422, etc.) holds one source picture in the source picture storage area (420). Thus, in some example implementations, a picture buffer (421, 422, etc.) can be configured to store an input sample for a current picture of a video sequence, where regional motion information is a property of the input sample. After one or more of the source pictures (411) have been stored in picture buffers (421, 422, etc.), a picture selector (430) selects an individual source picture from the source picture storage area (420). The order in which pictures are selected by the picture selector (430) for input to the encoder (440) may differ from the order in which the pictures are produced by the video source (410), e.g., the encoding of some pictures may be delayed in order, so as to allow some later pictures to be encoded first and to thus facilitate temporally backward prediction.

Before the encoder (440), the encoder system (400) can include a pre-processor (not shown) that performs pre-processing (e.g., filtering) of the selected picture (431) before encoding. The pre-processing can include color space conversion into primary (e.g., luma) and secondary (e.g., chroma differences toward red and toward blue) components and resampling processing (e.g., to reduce the spatial resolution of chroma components) for encoding.

The encoder (440) encodes the selected picture (431) to produce a coded picture (441) and also produces memory management control operation (“MMCO”) or reference picture set (“RPS”) information (442). If the current picture is not the first picture that has been encoded, when performing its encoding process, the encoder (440) may use one or more previously encoded/decoded pictures (469) that have been stored in a decoded picture temporary memory storage area (460). Such stored decoded pictures (469) are used as reference pictures for inter-picture prediction of the content of the current source picture (431). The MMCO/RPS information (442) indicates to a decoder which reconstructed pictures may be used as reference pictures, and hence are to be stored in a picture storage area.

Generally, the encoder (440) includes multiple encoding modules that perform encoding tasks such as partitioning into tiles, intra-picture prediction estimation and prediction, motion estimation and compensation, frequency transforms, quantization and entropy coding. The exact operations performed by the encoder (440) can vary depending on compression format. The format of the output encoded data can be H.26x format (e.g., H.261, H.262, H.263, H.264, H.265), Windows Media Video format, VC-1 format, MPEG-x format (e.g., MPEG-1, MPEG-2, or MPEG-4), VPx format (e.g., VP8, VP9), or another format.

The encoder (440) can partition a picture into multiple tiles of the same size or different sizes. For example, the encoder (440) splits the picture along tile rows and tile columns that, with picture boundaries, define horizontal and vertical boundaries of tiles within the picture, where each tile is a rectangular region. Tiles are often used to provide options for parallel processing. A picture can also be organized as one or more slices, where a slice can be an entire picture or section of the picture. A slice can be decoded independently of other slices in a picture, which improves error resilience. The content of a slice or tile is further partitioned into blocks for purposes of encoding and decoding.

For syntax according to the H.264 standard, the encoder (440) can partition a picture into multiple slices of the same size or different sizes. The encoder (440) splits the content of a picture (or slice) into 16×16 macroblocks. A macroblock includes luma sample values organized as four 8×8 luma blocks and corresponding chroma sample values organized as 8×8 chroma blocks. Generally, a macroblock has a prediction mode such as inter or intra. A macroblock includes one or more prediction units (e.g., 8×8 blocks, 4×4 blocks, which may be called partitions for inter-picture prediction) for purposes of signaling of prediction information (such as prediction mode details, motion vector (“MV”) information, etc.) and/or prediction processing. A macroblock also has one or more residual data units for purposes of residual coding/decoding.

For syntax according to the H.265 standard, the encoder (440) splits the content of a picture (or slice or tile) into coding tree units. A coding tree unit (“CTU”) includes luma sample values organized as a luma coding tree block (“CTB”) and corresponding chroma sample values organized as two chroma CTBs. The size of a CTU (and its CTBs) is selected by the encoder (440). A luma CTB can contain, for example, 64×64, 32×32 or 16×16 luma sample values. A CTU includes one or more coding units. A coding unit (“CU”) has a luma coding block (“CB”) and two corresponding chroma CBs. Generally, a CU has a prediction mode such as inter or intra. A CU includes one or more prediction units for purposes of signaling of prediction information (such as prediction mode details, etc.) and/or prediction processing. A prediction unit (“PU”) has a luma prediction block (“PB”) and two chroma PBs. A CU also has one or more transform units for purposes of residual coding/decoding, where a transform unit (“TU”) has a luma transform block (“TB”) and two chroma TBs. The encoder decides how to partition video into CTUs, CUs, PUs, TUs, etc.

As used herein, the term “block” can indicate a macroblock, residual data unit, CB, PB or TB, or some other set of sample values, depending on context. The term “unit” can indicate a macroblock, CTU, CU, PU, TU or some other set of blocks, or it can indicate a single block, depending on context, or it can indicate a slice, tile, picture, group of pictures, or other higher-level area.

Returning to FIG. 4, the encoder (440) compresses pictures using intra-picture coding and/or inter-picture coding. A general encoding control receives pictures as well as feedback from various modules of the encoder (440) and, potentially, a host application (not shown in FIG. 4). Overall, the general encoding control provides control signals to other modules (such as a tiling module, transformer/scaler/quantizer, scaler/inverse transformer, intra-picture estimator, motion estimator and intra/inter switch) to set and change coding parameters during encoding. For example, the general encoding control provides regional motion information, which it receives from a host application (as a property of an input sample for a picture, or otherwise), to a motion estimator, which can use the regional motion information, as described below. Or, as another example, the general encoding control receives commands from a host application based on results information from prior encoding, which the general encoding control can use to make quantization decisions, decisions about picture type, slice type, or macroblock type, or other decisions during encoding. Thus, the general encoding control can manage decisions about encoding modes during encoding. The general encoding control produces general control data that indicates decisions made during encoding, so that a corresponding decoder can make consistent decisions. Also, the general encoding control can provide results information to a host application, so as to help the host application make decisions to control encoding.

The encoder (440) represents an intra-picture-coded block of a source picture (431) in terms of prediction from other, previously reconstructed sample values in the picture (431). The picture (431) can be entirely or partially coded using intra-picture coding. Typically, an intra-picture-coded picture starts a video sequence, and another intra-picture-coded picture starts a sub-sequence after a scene change. Depending on format, an intra-picture-coded picture may have a picture type of “intra,” or it may include slices or macroblocks with type “intra.”

For intra spatial prediction for a block, the intra-picture estimator estimates extrapolation of the neighboring reconstructed sample values into the block (e.g., determines the direction of spatial prediction to use for the block). The intra-picture estimator can output prediction information (such as prediction mode/direction for intra spatial prediction), which is entropy coded. An intra-picture prediction predictor applies the prediction information to determine intra prediction values from neighboring, previously reconstructed sample values of the picture (431).

The encoder (440) represents an inter-picture-coded, predicted block of a source picture (431) in terms of prediction from one or more reference pictures. A decoded picture temporal memory storage area (460) (e.g., decoded picture buffer (“DPB”)) buffers one or more reconstructed previously coded pictures for use as reference pictures. A motion estimator estimates the motion of the block with respect to one or more reference pictures (469). When multiple reference pictures are used, the multiple reference pictures can be from different temporal directions or the same temporal direction. The motion estimator can use regional motion information provided by a host application to guide motion estimation for units of the picture (431). For example, the motion estimator starts motion estimation for a given unit at a location indicated by the regional motion information that is relevant for the given unit (e.g., by the regional motion information provided for a rectangle that includes the given unit). By starting motion estimation at that location, in many cases, the motion estimator more quickly identifies a suitable motion vector for the given unit. Typically, the regional motion information is determined relative to the immediately previous frame in display order (e.g., frame to frame motion). The motion estimator outputs motion information such as MV information and reference picture selection data, which is entropy coded. A motion compensator applies MVs to reference pictures (469) to determine motion-compensated prediction values for inter-picture prediction. If motion compensation is not effective for a unit, the unit can be encoded using intra-picture coding.

The encoder (440) can determine the differences (if any) between a block's prediction values (intra or inter) and corresponding original values. These prediction residual values are further encoded using a frequency transform (if the frequency transform is not skipped) and quantization. In general, a frequency transformer converts blocks of prediction residual data (or sample value data if the prediction is null) into blocks of frequency transform coefficients. In general, a scaler/quantizer scales and quantizes the transform coefficients. For example, the quantizer applies dead-zone scalar quantization to the frequency-domain data with a quantization step size that varies on a picture-by-picture basis, tile-by-tile basis, slice-by-slice basis, macroblock-by-macroblock basis, or other basis, where the quantization step size can be at least partially specified by a host application based on results information from previous encoding. Transform coefficients can also be scaled or otherwise quantized using other scale factors (e.g., weights in a weight matrix). Typically, the encoder (440) sets values for quantization parameter (“QP”) for a picture, tile, slice, macroblock, CU and/or other portion of video, and quantizes transform coefficients accordingly.

An entropy coder of the encoder (440) compresses quantized transform coefficient values as well as certain side information (e.g., MV information, reference picture indices, QP values, mode decisions, parameter choices). Typical entropy coding techniques include Exponential-Golomb coding, Golomb-Rice coding, arithmetic coding, differential coding, Huffman coding, run length coding, and combinations of the above. The entropy coder can use different coding techniques for different kinds of information, can apply multiple techniques in combination (e.g., by applying Golomb-Rice coding followed by arithmetic coding), and can choose from among multiple code tables within a particular coding technique.

With reference to FIG. 4, the coded pictures (441) and MMCO/RPS information (442) (or information equivalent to the MMCO/RPS information (442), since the dependencies and ordering structures for pictures are already known at the encoder (440)) are processed by a decoding process emulator (450). In a manner consistent with the MMCO/RPS information (442), the decoding processes emulator (450) determines whether a given coded picture (441) needs to be reconstructed and stored for use as a reference picture in inter-picture prediction of subsequent pictures to be encoded. If a coded picture (441) needs to be stored, the decoding process emulator (450) models the decoding process that would be conducted by a decoder that receives the coded picture (441) and produces a corresponding decoded picture (451). In doing so, when the encoder (440) has used decoded picture(s) (469) that have been stored in the decoded picture storage area (460), the decoding process emulator (450) also uses the decoded picture(s) (469) from the storage area (460) as part of the decoding process.

Thus, the decoding process emulator (450) implements some of the functionality of a decoder. For example, the decoding process emulator (450) performs inverse scaling and inverse quantization on quantized transform coefficients and, when the transform stage has not been skipped, performs an inverse frequency transform, producing blocks of reconstructed prediction residual values or sample values. The decoding process emulator (450) combines reconstructed residual values with values of a prediction (e.g., motion-compensated prediction values, intra-picture prediction values) to form a reconstruction. This produces an approximate or exact reconstruction of the original content from the video signal. (In lossy compression, some information is lost from the video signal.)

For intra-picture prediction, the values of the reconstruction can be fed back to the intra-picture estimator and intra-picture predictor. Also, the values of the reconstruction can be used for motion-compensated prediction of subsequent pictures. The values of the reconstruction can be further filtered. An adaptive deblocking filter is included within the motion compensation loop (that is, “in-loop” filtering) in the encoder (440) to smooth discontinuities across block boundary rows and/or columns in a decoded picture. Other filtering (such as de-ringing filtering, adaptive loop filtering (“ALF”), or sample-adaptive offset (“SAO”) filtering; not shown) can alternatively or additionally be applied as in-loop filtering operations.

The decoded picture temporary memory storage area (460) includes multiple picture buffer storage areas (461, 462, . . . , 46n). In a manner consistent with the MMCO/RPS information (442), the decoding process emulator (450) manages the contents of the storage area (460) in order to identify any picture buffers (461, 462, etc.) with pictures that are no longer needed by the encoder (440) for use as reference pictures, and remove such pictures. After modeling the decoding process, the decoding process emulator (450) stores a newly decoded picture (451) in a picture buffer (461, 462, etc.) that has been identified in this manner.

The encoder (440) produces encoded data in an elementary bitstream. The syntax of the elementary bitstream is typically defined in a codec standard or format. As the output of the encoder (440), the elementary bitstream is typically packetized or organized in a container format, as explained below. The encoded data in the elementary bitstream includes syntax elements organized as syntax structures. In general, a syntax element can be any element of data, and a syntax structure is zero or more syntax elements in the elementary bitstream in a specified order. For syntax according to the H.264 standard or H.265 standard, a network abstraction layer (“NAL”) unit is the basic syntax structure for conveying various types of information. A NAL unit contains an indication of the type of data to follow (NAL unit type) and a payload of the data in the form of a sequence of bytes.

For syntax according to the H.264 standard or H.265 standard, a picture parameter set (“PPS”) is a syntax structure that contains syntax elements that may be associated with a picture. A PPS can be used for a single picture, or a PPS can be reused for multiple pictures in a sequence. A PPS is typically signaled separate from encoded data for a picture. Within the encoded data for a picture, a syntax element indicates which PPS to use for the picture. Similarly, for syntax according to the H.264 standard or H.265 standard, a sequence parameter set (“SPS”) is a syntax structure that contains syntax elements that may be associated with a sequence of pictures. A bitstream can include a single SPS or multiple SPSs. An SPS is typically signaled separate from other data for the sequence, and a syntax element in the other data indicates which SPS to use.

The coded pictures (441) and MMCO/RPS information (442) are buffered in a temporary coded data area (470) or other coded data buffer. Thus, in some example implementations, a buffer can be configured to store an output sample for a current picture of a video sequence, where results information is a property of the output sample. The coded data that is aggregated in the coded data area (470) contains, as part of the syntax of the elementary bitstream, encoded data for one or more pictures. The coded data that is aggregated in the coded data area (470) can also include media metadata relating to the coded video data (e.g., as one or more parameters in one or more supplemental enhancement information (“SEI”) messages or video usability information (“VUI”) messages).

The aggregated data (471) from the temporary coded data area (470) is processed by a channel encoder (480). The channel encoder (480) can packetize and/or multiplex the aggregated data for transmission or storage as a media stream (e.g., according to a media program stream or transport stream format such as ITU-T H.222.0|ISO/IEC 13818-1 or an Internet real-time transport protocol format such as IETF RFC 3550), in which case the channel encoder (480) can add syntax elements as part of the syntax of the media transmission stream. Or, the channel encoder (480) can organize the aggregated data for storage as a file (e.g., according to a media container format such as ISO/IEC 14496-12), in which case the channel encoder (480) can add syntax elements as part of the syntax of the media storage file. Or, more generally, the channel encoder (480) can implement one or more media system multiplexing protocols or transport protocols, in which case the channel encoder (480) can add syntax elements as part of the syntax of the protocol(s). The channel encoder (480) provides output to a channel (490), which represents storage, a communications connection over a network, or another channel for the output. The channel encoder (480) or channel (490) may also include other elements (not shown), e.g., for forward-error correction (“FEC”) encoding and analog signal modulation.

### V. Example Uses of Information to Assist Video Encoder.

This section describes ways for a host application to share information with a video encoder to help the video encoder perform certain encoding operations. For example, the host application provides regional motion information to a video encoder, which uses the regional motion information to guide motion estimation operations for a current picture. This can speed up motion estimation by allowing the video encoder to identify suitable motion vectors for units of the current picture more quickly, and more generally improve the accuracy and quality of motion estimation.

A. Techniques for Using Regional Motion Information to Assist Encoding.

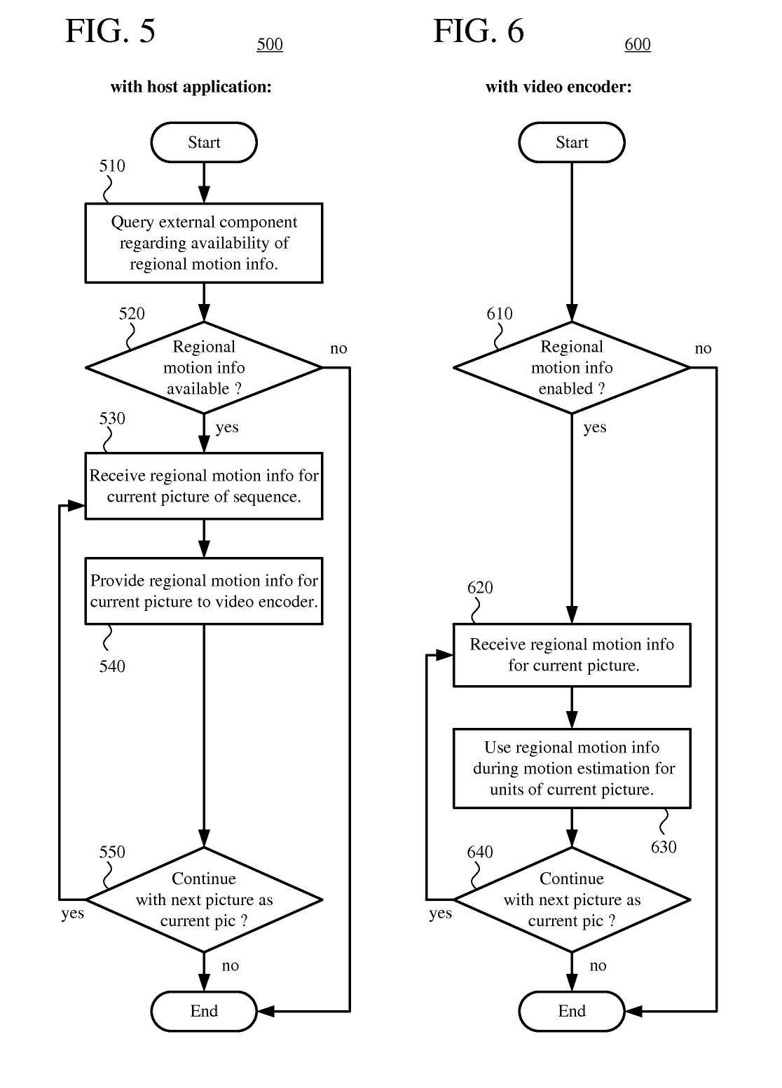

FIG. 5 shows a generalized technique (500) for using regional motion information to assist video encoding, from the perspective of a host application. FIG. 6 shows a corresponding generalized technique (600) for using regional motion information to assist video encoding, from the perspective of a video encoder.

A host application selectively enables use of regional motion information by a video encoder. With reference to FIG. 5, for example, the host application queries (510) an operating system component or other external component regarding the availability of regional motion information. If regional motion information is available, the host application enables (520) the use of regional motion information by the video encoder. For example, the video encoder exposes an interface that includes a property (e.g., attribute) indicating whether the use of regional motion information is enabled or not enabled, and the host application sets a value of the property to enable the use of regional motion information by the video encoder. Alternatively, the host application enables the use of regional motion information by the video encoder in some other way.

The host application receives (530) regional motion information for a current picture of a video sequence. The host application then provides (540) the regional motion information for the current picture to the video encoder. For example, the regional motion information is provided to the video encoder as a property (e.g., attribute) of an input sample for the current picture. Alternatively, the regional motion information is provided to the video encoder in some other way, e.g., as an event, as one or more parameters to a method call. The host application checks (550) whether to continue with the next picture as the current picture. If so, the host application receives (530) regional motion information for that picture and provides (540) the regional motion information to the video encoder.

With reference to FIG. 6, the video encoder checks (610) whether use of regional motion information is enabled. If so, the video encoder receives (620) regional motion information for a current picture and uses (630) the regional motion information during motion estimation for units of the current picture. For example, the regional motion information is provided to the video encoder as a property (e.g., attribute) of an input sample for the current picture. Alternatively, the regional motion information is provided to the video encoder in some other way, e.g., as an event, as one or more parameters to a method call. The video encoder checks (640) whether to continue with the next picture as the current picture. If so, the video encoder receives (620) regional motion information for that picture and uses (630) the regional motion information during motion estimation for units of the picture.

The organization of the regional motion information depends on implementation. For example, the regional motion information includes, for each of one or more rectangles in an input sample for the current picture, (a) information defining the rectangle, and (b) motion parameters for the rectangle. The motion parameters can indicate a motion vector (“MV”), which is a two-dimensional transformation, an affine transformation, or a perspective transformation. Alternatively, the regional motion information is specified for some other shape, e.g., an arbitrary region in the current picture.

When it uses the regional motion information, the video encoder can find an initial MV for a given unit by applying the appropriate regional motion information to use for the given unit. For example, the video encoder determines the initial MV of the rectangle or other shape that includes the given unit. If the regional motion information is an MV, that MV is used as the initial MV for the given unit. Otherwise, the initial MV for the given unit is calculated by applying the regional motion information (e.g., affine transform coefficients, perspective transform coefficients) to determine an average motion or other representative motion for the given unit. The video encoder starts motion estimation for the given unit at a location indicated by the initial MV for the given unit. By starting motion estimation at that location, in many cases, the motion estimator more quickly identifies a suitable motion vector for the given unit.

The regions (e.g., rectangles or other shapes) for which regional motion information is provided can entirely cover the current picture. Or, the regions for which regional motion information is specified can cover only part of the current picture. In this case, any part of the current picture that does not have regional motion information provided for it can have a default motion such as a (0, 0) MV.

In many cases, a unit at the boundary of a region (e.g., rectangle or other shape) does not have the motion indicated with the regional motion information. Instead, the unit can have more complicated motion that blends the motion of an adjacent region and/or can include non-moving parts. For this reason, a unit at the boundary of a region can be encoded using intra-picture coding if motion estimation and compensation are unlikely to be effective. Or, a unit at the boundary of a region can be split into smaller units for purposes of motion estimation and compensation, such that different sub-units of the unit have different MVs and/or selected sub-units of the unit are intra-picture coded. For example, a 16×16 unit is split into four 8×8 sub-units, each of which may be further split into smaller sub-units. In this way, motion for the sub-units can more closely track actual motion while at least some sub-units use the regional motion information.

During motion estimation for a unit, an encoder can apply a cost penalty when evaluating any MV that is different than the initial MV for the unit (which depends on the appropriate regional motion information provided by the host application). For example, in addition to accounting for a bit rate cost and distortion cost when evaluating a candidate MV, the encoder can add a cost penalty if the candidate MV is different than the initial MV for the unit. The amount of the cost penalty depends on implementation, and it can be static or dynamic (as explained below). Using the cost penalty during motion estimation encourages the selection of MVs that match regional motion information provided by the host application.

The encoder can periodically verify the effectiveness of motion estimation that uses regional motion information provided by the host application. For example, after the current picture has been encoded, the encoder can evaluate how many units (or, alternatively, how many motion-compensated units) of the current picture were encoded using MVs indicated by the regional motion information provided for the current picture. The actual proportion of units (or motion-compensated units) encoded using MVs indicated by the regional motion information can be compared to a target proportion to assess performance. The actual proportion and target proportion can be percentages, absolute counts of units, or some other measure. The target proportion depends on implementation (e.g., 80%, 85%, 90%). Alternatively, instead of evaluating proportions for units of the current picture, the encoder can evaluate proportions for area of the current picture (that is, proportion of area of the current picture, or motion-compensated area of the current picture, encoded using MVs indicated by the regional motion information). The encoder can verify the effectiveness of regional motion information for each picture encoded using motion estimation and compensation, or it can verify effectiveness every x pictures (where x is 2, 3, 4, etc.).

The encoder can use the results of the verification process to adjust its motion estimation process. For example, the encoder can change a cost penalty (for deviation from regional motion information) depending on the results of the verification process (e.g., increasing the cost penalty if a target proportion is not reached, so as to make it more likely for the target proportion to be reached during subsequent encoding; or, decreasing the cost penalty if the target proportion is exceeded, making the encoder more tolerant of deviation from the regional motion information during subsequent encoding). Alternatively, the encoder can use the results of the verification process to adjust in some other way its motion estimation process during subsequent encoding.

When providing regional motion information, the host application can control the video encoder during real-time communication. In particular, in real-time video communication scenarios, speed of encoding is important to satisfy latency requirements. Also, as in most video delivery scenarios, encoding quality is important. Alternatively, the host application controls the video encoder during some other video delivery scenario.

B. Example Implementations.

In some example implementations, an interface of a video encoder is extended to include an attribute or property (generally, “property”) that can be set to enable the use of regional motion information during video encoding. The property can be a publicly documented extension of the interface or a private extension of the interface. The property, whose value can be set by a host application, can be a “static” property whose value is unchangeable after the value is set prior to initialization of the video encoder (unless the video encoder is re-initialized). Or, the property can be a “dynamic” property whose value may be changed during encoding with the video encoder. The value of the property can be retrieved or set using conventional methods for getting or setting the value of a property of the interface. The interface can also permit queries of whether the property is supported or not supported, as well as queries about which values are allowed for the property.

The following code fragment shows operations involving a property called AVEncVideoRegionalMVEnabled, which is part of an interface called ICodecAPI. The data type of AVEncVideoRegionalMVEnabled is a byte array, but alternatively the data type could be a Boolean (flag value), integer, or other type of value. AVEncVideoRegionalMVEnabled is used to indicate whether a property (e.g., attribute) called RegionalMVInfo is set on an input sample. If the value of AVEncVideoRegionalMVEnabled is zero, regional motion information is not provided for an input sample. On the other hand, if AVEncVideoRegionalMVEnabled has a non-zero value, regional motion information can be provided for an input sample and, if provided, can be used by a video encoder to guide motion estimation. The default value of AVEncVideoRegionalMVEnabled is zero. The value of AVEncVideoRegionalMVEnabled can be set using the SetValue( ) method or retrieved using the GetValue( ) method. With a call to the IsSupported( ) method, a caller can determine whether AVEncVideoRegionalMVEnabled is supported by the interface.

With the following code fragment, a host application checks whether the property AVEncVideoRegionalMVEnabled is supported on an ICodecAPI interface exposed by a video encoder. If so, the host application sets the value of AVEncVideoRegionalMVEnabled to 1.

if (pCodecAPI−>IsSupported(&CODECAPI_AVEncVideoRegionalMVEnabled) == S_OK)

{

VARIANT var;
var.vt = VT_UI4;
var. ulVal =1;
CHECKHR_GOTO_DONE (pCodecAPI−>SetValue(&CODECAPI_ AVEncVideo

RegionalMVEnabled, & var));

}

In this code fragment, the host application calls the IsSupported( ) method of the ICodecAPI interface exposed by the video encoder, passing a pointer to an identifier (e.g., GUID) associated with the property AVEncVideoRegionalMVEnabled. If AVEncVideoRegionalMVEnabled is supported (“S_OK” returned), a variable var is created and assigned the value 1. Then, the property AVEncVideoRegionalMVEnabled is assigned the variable var using the method SetValue( ).

The regional motion information can be represented using the property RegionalMVInfo, which is an array of bytes (so-called “blob” data type). The array of bytes can be a serialized version of the REGIONAL_MV_INFO structure, which is defined as follows.

typedef struct _ REGIONAL_MV_INFO {

RECT rects[MAX_RECT_REGIONAL_MV];
float regionalMVs[MAX_RECT_REGIONAL_MV][3][3];

} REGIONAL_MV_INFO, * REGIONAL_MV_INFO;

The constant MAX_RECT_REGIONAL_MV has a value that depends on implementation (e.g., 4, or some other number), and the variable rects is an array of parameters that specify the positions and dimensions of different rectangles in a frame. For example, for each rectangle, parameters in the rects array indicate a top-left corner and bottom-right corner of the array. Alternatively, a rectangle can be parameterized in some other way (e.g., top-left corner, height, and width). The rectangles can be overlapping or non-overlapping. For each of the rectangles, the variable regionalMVs is an array of parameters that specify the regional motion information for that rectangle. The regional motion information can be a MV for a rectangle. Or, the regional motion information can be affine transform coefficients for the rectangle, which permit specification of translation motion, scaling, or rotation for the rectangle. When scaling is used, the scaling center for the rectangle can be the center of the rectangle. In some implementations, the regional motion is limited to translation and scaling (zooming in or out). Or, the regional motion information can be perspective transform coefficients for the rectangle. Regardless of how the regional motion information is specified, different rectangles can have different regional motions. If all of the rectangles have the same motion, or if a single rectangle has motion specified for an entire picture, the regional motion information is in effect global motion information.

If the property AVEncVideoRegionalMVEnabled has a non-zero value for the video encoder, a REGIONAL_MV_INFO structure can store regional motion information for rectangles of a picture, and then be set as the value of the RegionalMVInfo property (e.g., attribute) of an input sample for the picture. The video encoder may then use the regional motion information for motion estimation. The value of the RegionalMVInfo property is effective for one picture. Otherwise (that is, when the value of AVEncVideoRegionalMVEnabled is zero), the RegionalMVInfo property is ignored by the video encoder even if provided with an input sample.

VI. Example Uses of Results Information from Video Encoder.

This section describes ways for a video encoder to share information with a host application to help the host application control overall encoding. For example, the video encoder provides the host application with information about the results of encoding a current picture, such as a quantization value and a measure of intra unit usage for the current picture. The host application can use the results information to control encoding for one or more subsequent pictures, e.g., determining when to start a new group of pictures at a scene change boundary, or otherwise controlling syntax or properties during encoding of the subsequent picture(s).

A. Techniques for Using Results Information to Assist Encoding Control.

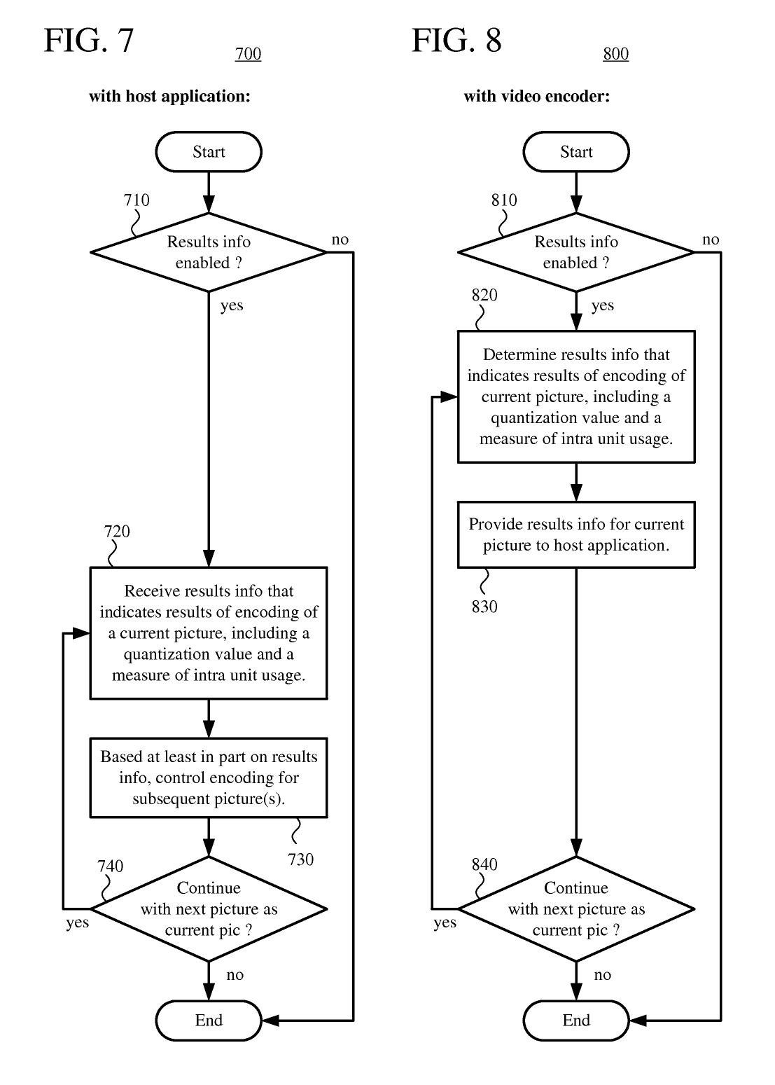

FIG. 7 shows a generalized technique (700) for using results information to control video encoding, from the perspective of a host application. FIG. 8 shows a corresponding generalized technique (800) for using results information to control video encoding, from the perspective of a video encoder.

With reference to FIG. 8, a video encoder checks (810) whether the export of results information is enabled. The video encoder can expose an interface that includes a property (e.g., attribute) indicating whether the export of results information is enabled or not enabled, and the host application can set a value of the property to enable the export of results information by the video encoder. Alternatively, the host application enables the export of results information by the video encoder in some other way.

If the export of results information by the video encoder is enabled, the video encoder determines (820) results information that indicates the results of encoding of a current picture by the video encoder. The results information includes a quantization value and a measure of intra unit usage, which together provide a good indication of the quality of encoding. The quantization value is, for example, an average quantization parameter or average quantization step size for the current picture. More generally, the quantization value indicates a tradeoff between distortion and bitrate for the current picture. The measure of intra unit usage generally indicates how many units of the current picture were encoded using intra-picture compression, as opposed to inter-picture compression. The measure of intra unit usage can be a percentage of intra units in the current picture, a ratio of intra units to inter units in the current picture, or another metric. A high value for the measure of intra unit usage may indicate a scene change (and hence high bit usage for the particular picture), since motion estimation/compensation has failed for many units.

The video encoder provides (830) the results information for the current picture to the host application. For example, the results information is provided to the host application as a property (e.g., attribute) of an output sample for the current picture, or is associated with the output sample for the current picture in some other way. Alternatively, the results information is provided to the host application in some other way, e.g., as an event, as one or more parameters to a method call. The video encoder checks (840) whether to continue with the next picture as the current picture. If so, the video encoder determines (820) results information for that picture and provides (830) the results information to the host application.

With reference to FIG. 7, the host application checks (710) whether the export of results information by a video encoder is enabled. For example, the host application checks the value of a property of an interface exposed by the video encoder, which can be set as described above. In some cases, the host application can enable the export of results information by the video encoder. For example, when the video encoder exposes an interface that includes a property indicating whether the export of results information is enabled or not enabled, the host application can set a value of the property to enable the export of results information.

If the export of results information is enabled, the host application receives (720) results information that indicates the results of encoding of a current picture of a video sequence by the video encoder. The results information includes a quantization value and a measure of intra unit usage. As described below, the results information can be received by the host application as an attribute of an output sample for the current picture. Or, the results information can be received in some other way. Based at least in part on the results information, the host application controls (730) encoding for one or more subsequent pictures of the video sequence. For example, the host application sets a quantization parameter for at least one part of the subsequent picture(s) based at least in part on the results information. Using the results information, the host application can gradually transition between values of quantization parameter. Or, the host application sets a picture type for at least one of the subsequent picture(s) based at least in part on the results information. This can happen after a scene change, which may be indicated by a large number of intra-picture-coded blocks due to failure of motion estimation/compensation. For example, the host application compares the measure of intra unit usage (from the results information) to a threshold. Based at least in part on results of the comparing, the host application sets a picture type to intra for a next picture among the subsequent picture(s). Or, the host application controls encoding by controlling properties of the encoder, input samples, or encoding operations. The host application checks (740) whether to continue with the next picture as the current picture. If so, the host application receives (720) results information that indicates results of encoding of the picture and, based at least in part on the results information, controls (730) encoding for subsequent picture(s) of the video sequence (e.g., controlling properties of the encoder, input samples, or encoding operations).

When using results information, the host application can control the video encoder during real-time communication. Alternatively, the host application controls the video encoder during some other video delivery scenario.

B. Example Implementations.

In some example implementations, an interface of a video encoder is extended to include an attribute or property (generally, “property”) that can be set to enable the export of results information during video encoding. The property can be a publicly documented extension of the interface or a private extension of the interface. The property, whose value can be set by a host application, can be a “static” property whose value is unchangeable after the value is set prior to initialization of the video encoder (unless the video encoder is re-initialized). Or, the property can be a “dynamic” property whose value may be changed during encoding with the video encoder. The value of the property can be retrieved or set using conventional methods for getting or setting the value of a property of the interface. The interface can also permit queries of whether the property is supported or not supported, as well as queries about which values are allowed for the property.

The following code fragment shows operations involving a property called AVEncVideoEncodingInfoEnabled, which is part of an interface called ICodecAPI. The data type of AVEncVideoEncodingInfoEnabled is a byte array, but alternatively the data type could be a Boolean (flag value), integer, or other type of value. AVEncVideoEncodingInfoEnabled is used to indicate whether a property (e.g., attribute) called EncodingFrameInfo is set on an output sample. If the value of AVEncVideoEncodingInfoEnabled is zero, results information is not provided for an output sample. On the other hand, if AVEncVideoEncodingInfoEnabled has a non-zero value, results information can be provided for an output sample and, if provided, can be used by a host application to control video encoding. The default value of AVEncVideoEncodingInfoEnabled is zero. The value of AVEncVideoEncodingInfoEnabled can be set using the SetValue( ) method or retrieved using the GetValue( ) method. With a call to the IsSupported( ) method, a caller can determine whether AVEncVideoEncodingInfoEnabled is supported by the interface.

With the following code fragment, a host application checks whether the property AVEncVideoEncodingInfoEnabled is supported on an ICodecAPI interface exposed by a video encoder. If so, the host application sets the value of AVEncVideoEncodingInfoEnabled to 1.

if (pCodecAPI−>IsSupported(&CODECAPI_AVEncVideoEncodingInfoEnabled) == S_OK)
{

VARIANT var;
var.vt = VT_UI4;
var. ulVal =1;
CHECKHR_GOTO_DONE (pCodecAPI−>SetValue(&CODECAPI_AVEncVideoEncoding

InfoEnabled, & var));

}

In this code fragment, the host application calls the IsSupported( ) method of the ICodecAPI interface exposed by the video encoder, passing a pointer to an identifier (e.g., GUID) associated with the property AVEncVideoEncodingInfoEnabled. If AVEncVideoEncodingInfoEnabled is supported (“S_OK” returned), a variable var is created and assigned the value 1. Then, the property AVEncVideoEncodingInfoEnabled is assigned the variable var using the method SetValue( ) of the ICodecAPI interface exposed by the video encoder.

The results information can be represented using the property EncodingFrameInfo, which is an array of bytes (so-called “blob” data type). The array of bytes can be a serialized version of the ENCODING_FRAME_INFO structure, which is defined as follows.

typedef struct _ENCODING_FRAME_INFO {

INT32 averageQP;
float intraPercent;

} ENCODING_FRAME_INFO, * ENCODING_FRAME_INFO;

The integer averageQP indicates the average quantization parameter used to encode the current picture, and the floating point value intraPercent indicates the percentage of intra-coded blocks in the current picture. Alternatively, the EncodingFrameInfo property includes other and/or additional kinds of results information.

If the property AVEncVideoEncodingInfoEnabled has a non-zero value for the video encoder, an ENCODING_FRAME_INFO structure can store results information, and then be set as the value of the EncodingFrameInfo property (e.g., attribute) of an output sample for the picture. The host application may then use the results information to control various aspects of encoding. The value of the EncodingFrameInfo property is effective for one picture. Otherwise (that is, when the value of AVEncVideoEncodingInfoEnabled is zero), the EncodingFrameInfo property is ignored by the host application even if provided with an output sample.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1.-15. (canceled)

16. A system comprising:
a buffer configured to store an input sample for a current picture of a video sequence;
a video encoder configured to:
determine results information that indicates results of encoding of the current picture by the video encoder, the results information including a quantization value and a measure of intra unit usage; and
associate the results information with an output sample for the current picture; and
a buffer configured to store the output sample for the current picture.

17. The system of claim 16, wherein the video encoder is further configured to:
receive regional motion information for the current picture; and
use the regional motion information during motion estimation for units of the current picture.

18. The system of claim 17, wherein the regional motion information is a property of the input sample, and wherein the results information is a property of the output sample.

19. The system of claim 17, further comprising a host application configured to:
receive the regional motion information for the current picture from an external component;
provide the regional motion information for the current picture to the video encoder;
receive the results information; and
based at least in part on the results information, control encoding for one or more subsequent pictures of the video sequence.

20. The system of claim 16, wherein the video encoder is further configured to expose an interface that includes:
a property indicating whether export of results information is enabled or not enabled; and
a property indicating whether use of regional motion information is enabled or not enabled.

21. One or more computer-readable media storing computer-executable instructions for causing a computer system, when programmed thereby, to perform media processing operations comprising:
with a host application running on the computer system, selectively enabling use of regional motion information by a video encoder;
with the host application, receiving regional motion information for a current picture of a video sequence; and
with the host application, providing the regional motion information for the current picture to the video encoder.

22. The one or more computer-readable media of claim 21, wherein the media processing operations further comprise:
with the host application, querying an operating system component or other external component regarding availability of regional motion information; and
with the host application, if regional motion information is available, enabling the use of regional motion information by the video encoder.

23. The one or more computer-readable media of claim 22, wherein the video encoder exposes an interface that includes a property indicating whether the use of regional motion information is enabled or not enabled, and wherein the host application sets a value of the property to enable the use of regional motion information by the video encoder.

24. The one or more computer-readable media of claim 21, wherein the regional motion information is provided to the video encoder as a property of an input sample for the current picture.

25. The one or more computer-readable media of claim 21, wherein the regional motion information includes, for each of one or more rectangles or other shapes in an input sample for the current picture:
information defining the rectangle or other shape; and
motion parameters for the rectangle or other shape.

26. The one or more computer-readable media of claim 21, wherein the host application controls the video encoder during real-time communication.

27. The one or more computer-readable media of claim 21, wherein the media processing operations further comprise:
with the host application, receiving results information that indicates results of encoding of the current picture, the results information including one or more of a quantization parameter and a measure of intra unit usage; and
with the host application, based at least in part on the results information, controlling encoding for one or more subsequent pictures of the video sequence.

28. A method comprising:
with a host application running on a computer system, receiving results information that indicates results of encoding of a current picture of a video sequence by a video encoder, the results information including a quantization value and a measure of intra unit usage; and
with the host application, based at least in part on the results information, controlling encoding for one or more subsequent pictures of the video sequence.

29. The method of claim 28, wherein the controlling the encoding includes one or more of:
setting a quantization parameter for at least one part of the one or more subsequent pictures; and
setting a picture type for at least one of the one or more subsequent pictures.

30. The method of claim 28, wherein the controlling the encoding includes:
comparing the measure of intra unit usage to a threshold; and
based at least in part on results of the comparing, setting a picture type to intra for a next picture among the one or more subsequent pictures.

31. The method of claim 28, further comprising:
with the host application, enabling export of results information by the video encoder.

32. The method of claim 31, wherein the video encoder exposes an interface that includes a property indicating whether the export of results information is enabled or not enabled, and wherein the host application sets a value of the property to enable the export of results information.

33. The method of claim 28, wherein the results information is received by the host application as a property of an output sample for the current picture.

34. The method of claim 28, wherein the host application controls the video encoder during real-time communication.

35. The method of claim 28, further comprising:
with the host application, receiving regional motion information for the current picture; and
with the host application, providing the regional motion information for the current picture to the video encoder.
